(19) United States
(12) Patent Application Publication
(10) Pub. No.: US 2024/0309705 A1
(43) Pub. Date: Sep. 19, 2024

(54) DOWNHOLE HIGH-POWER LASER TOOL FOR SUBSURFACE APPLICATIONS

(71) Applicant: SAUDI ARABIAN OIL COMPANY, Dhahran (SA)

(72) Inventors: Saad Menahi Mutairi, Dhahran (SA); Sameeh Issa Batarseh, Dhahran (SA); Damian Pablo San Roman Alerigi, Al Khobar (SA)

(73) Assignee: SAUDI ARABIAN OIL COMPANY, Dhahram (SA)

(21) Appl. No.: 18/185,740

(22) Filed: Mar. 17, 2023

(51) Int. Cl. E21B 7/15; E21B 43/119

(52) U.S. Cl. CPC E21B 7/15; E21B 43/119

(57) ABSTRACT

In one aspect, a downhole laser tool includes: a laser unit including a laser that generates a laser beam in a downhole environment of a well; a first segment including one or more lenses of the first segment, a first retractable reflector, and a first aperture, wherein the one or more lenses of the first segment and the first retractable reflector guide the laser beam to the first aperture that passes the laser beam to the downhole environment; and a first rotational joint, disposed between the laser unit and the first segment, that connects the laser unit to the first segment and rotates the first segment. The laser unit, the first rotational joint, and the first segment are disposed longitudinally along the well. During operation of the downhole laser tool, the laser unit, the first rotational joint, and the first segment navigate in the downhole environment as one integral tool.

### BACKGROUND

Hydrocarbon fluids are often found in hydrocarbon reservoirs located in porous rock formations below the surface of the Earth. Wells are drilled into the reservoirs to access and produce the hydrocarbon fluids. High-power laser can be useful for downhole applications, for example, for maximum hydrocarbon recovery, heating, troubleshooting, treatment, stimulation, perforation, and drilling. However, there are some challenges in using high-power lasers for downhole applications. One challenge is power loss from the laser source to the tool that operates below the surface. Another challenge is potential need for changing the laser tool with respect to different applications below the surface.

### SUMMARY

This summary is provided to introduce a selection of concepts that are further described below in the detailed description. This summary is not intended to identify key or essential features of the claimed subject matter, nor it is intended to be used as an aid in limiting the scope of the claimed subject matter.

This disclosure presents, in accordance with one or more embodiments, a downhole laser tool that includes: a laser unit including a laser that generates a laser beam in a downhole environment of a well; a first segment including one or more lenses of the first segment, a first retractable reflector, and a first aperture; and a first rotational joint, disposed between the laser unit and the first segment, that connects the laser unit to the first segment and rotates the first segment. The one or more lenses of the first segment and the first retractable reflector guide the laser beam to the first aperture that passes the laser beam to the downhole environment. The laser unit, the first rotational joint, and the first segment are disposed longitudinally along the well. During operation of the downhole laser tool, the laser unit, the first rotational joint, and the first segment navigate in the downhole environment as one integral tool. In one or more embodiments, the downhole laser tool may be configured to function as all-in-one tool for targeting different applications in one run. This may save operation time and cost because it may eliminate changing and adjusting the tool for each specific application.

In another aspect, this disclosure also presents, in accordance with one or more embodiments, a method for operating a downhole laser tool. The method includes: lowering the downhole laser tool in a downhole environment of a well; turning ON a laser unit, the laser unit comprising a laser emitting a laser beam; guiding the laser beam, through a first segment of the downhole laser tool, using one or more lenses of the first segment and a first retractable reflector of the first segment; controlling retraction of the first retractable reflector to guide the laser beam to a first aperture of the first segment that passes the laser beam to the downhole environment; controlling rotation of a first rotational joint, disposed between the laser unit and the first segment, that connects the laser unit to the first segment and rotates the first aperture; and ejecting a fluid to an outer side of the first aperture, to sweep debris away from the first aperture. In the lowering of the downhole laser tool in the downhole environment, the laser unit, the first rotational joint, and the first segment are disposed longitudinally along the well. During operation of the downhole laser tool, the laser unit, the first rotational joint, and the first segment navigate in the downhole environment as one integral tool.

Other aspects and advantages of the invention will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an exemplary well in accordance with one or more embodiments disclosed herein.

FIG. 2 shows deploying a downhole laser tool in a well, in accordance with one or more embodiments disclosed herein.

FIG. 3 shows a downhole laser tool, in accordance with one or more embodiments disclosed herein.

FIG. 4 shows a first segment of a downhole laser tool, in accordance with one or more embodiments disclosed herein.

FIG. 5 shows a second segment of a downhole laser tool, in accordance with one or more embodiments disclosed herein.

FIG. 6 shows a third segment of a downhole laser tool, in accordance with one or more embodiments disclosed herein.

FIG. 7A shows an exemplified application of a first segment of a downhole laser tool, in accordance with one or more embodiments disclosed herein.

FIG. 7B shows an exemplified application of a third segment of a downhole laser tool, in accordance with one or more embodiments disclosed herein.

FIG. 8 shows a flow chart for operating a downhole laser tool, in accordance with one or more embodiments disclosed herein.

FIG. 9 shows a computer system for operating a downhole laser tool, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the disclosure, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements. In addition, throughout the disclosure, “or” is interpreted as “and/or,” unless stated otherwise.

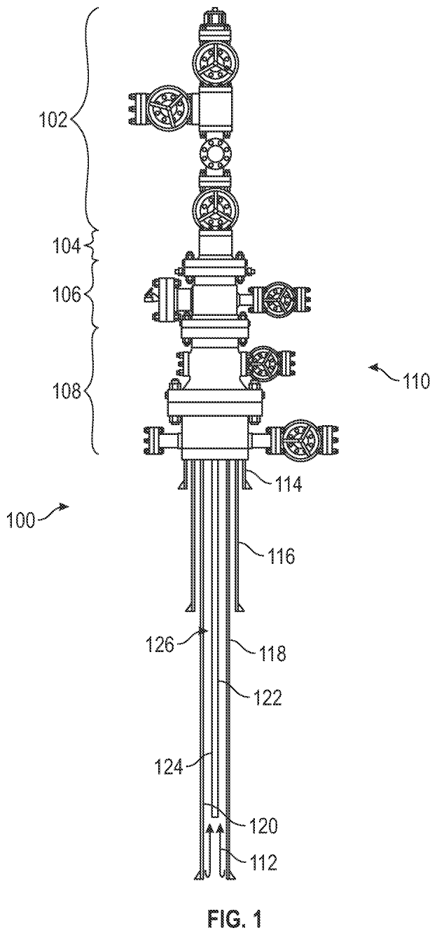

One or more embodiments disclosed herein describe a high-power laser unit integrated with a multifunctional tool that can perform different applications inside a well. In this disclosure, the integral of the laser unit and the multifunctional tool is referred to as “downhole laser tool.” For better understanding the downhole laser tool, embodiments of an exemplary well is described below with reference to FIG. 1.

FIG. 1 shows an exemplary well (100) in accordance with one or more embodiments. The well (100) includes a tree (102), a tubing bonnet (104), a tubing head (106), and a casing head (108) located on a surface location (110) that may be located anywhere on the Earth's surface. The tree (102) has a plurality of valves that control the production of production fluids (e.g., hydrocarbon fluids) (112) that come from a production zone located beneath the surface location (110). The valves also allow for access to the subsurface portion of the well (100).

The well (100) has three strings of casing: conductor casing (114), surface casing (116), and production casing (118). The casing strings are made of a plurality of long high-diameter tubulars threaded together. The tubulars may be made out of any durable material known in the art, such as steel. The casing strings are cemented in place within the well (100). The casing strings may be fully or partially cemented in place without departing from the scope of the disclosure herein.

Each string of casing, starting with the conductor casing (114) and ending with the production casing (118), decreases in both outer diameter and inner diameter such that the surface casing (116) is nested within the conductor casing (114) and the production casing (118) is nested within the surface casing (116). Upon completion of the well (100), the inner circumferential surface (120) of the production casing (118) and the space located within the production casing (118), make up the interior of the well (100).

The majority of the length of the conductor casing (114), surface casing (116), and production casing (118) are located underground. However, the surface-extending portion of each casing string is housed in the casing head (108), also known as a wellhead, located at the surface location (110). The surface-extending portion of each casing string may include a casing hanger (not pictured) that is specially machined to be set and hung within the casing head (108). There may be multiple casing heads (108) depending on the number of casing strings without departing from the scope of the disclosure herein.

Production tubing (122) is deployed within the production casing (118). The production tubing (122) may include a plurality of tubulars connected together and may be interspersed with various pieces of equipment such as artificial lift equipment, packers, etc. The space formed between the outer circumferential surface (124) of the production tubing (122) and the inner circumferential surface (120) of the production casing (118) is called the tubing-casing annulus (126).

The majority of the length of the production tubing (122) is located in the interior of the well (100) underground. However, the surface-extending portion of the production tubing (122) is housed in the tubing head (106) which is installed on top of the casing head (108). The surface-extending portion of the production tubing (122) may include a tubing hanger (not pictured) that is specially machined to be set and hung within the tubing head (106). The tree (102) is connected to the top of the tubing head (106) using the tubing bonnet (104). The tubing bonnet (104) is an adapter comprising one or more seals (not pictured).

In accordance with one or more embodiments, the production casing (118) may comprise a portion made of slotted casing or screen such that production fluids may flow into the production casing (118) from the formation. In other embodiments, the production casing (118) may include perforations made through the production casing (118), cement, and wellbore in order to provide a pathway for the production fluids (112) to flow from the production zone into the interior of the well (100).

The production fluids (112) may travel from the interior of the well (100) to the surface location (110) through the production tubing (122). A pipeline (not pictured) may be connected to the tree (102) to transport the production fluids (112) away from the well (100). The well (100) depicted in FIG. 1 is one example of a well (100) but is not meant to be limiting. The scope of this disclosure encompasses any well (100) design that has at least one string of casing in the well (100). Further, the well (100) may have other variations of surface equipment without departing from the scope of this disclosure.

The downhole laser tool in accordance with one or more embodiments can be used for several applications inside the well. The applications may include, but are not limited to, drilling the well, perforating sidewalls of the well, treatment of a casing, sealing, heating, and stimulation of the reservoir. For the downhole laser tool, in accordance with one or more embodiments, a commercially available high-power compact laser such as a Direct Diode Laser may be used. Direct Diode Lasers can have efficiency, compact size, and low weight. Some of commercially available high-power Direct Diode Lasers can produce laser power as much as 10 kilowatts (kW), which is sufficiently high for several subsurface applications described below in accordance with one or more embodiments. The power loss of the laser can be minimized, in accordance with one or more embodiments, by integrating the high-power laser tool in the downhole laser tool. In one or more embodiments, by integrating a 10 kW high-power laser, the laser power on a subsurface target may be close to 10 kW. Table 1 and Table 2 below show examples of Direct Diode Lasers for straight line beam and circular beam, which are two shapes of the laser beam, respectively.

TABLE 1

| | HighLight4000D | HighLight8000D | HighLight10000D |
|---|---|---|---|
| Power (kW) | 4 | 8 | 10 |
| Wavelength | 975 | 975 | 975 |
| (nanometers (nm)) | | | |
| Size of line beam: | | | |
| Length | 4 to 30 | 6 to 36 | 6 to 36 |
| (millimeters (mm)) | | | |
| Width (mm) | 1 to 12 | 1 to 12 | 1 to 12 |

TABLE 2

| | | Output | Operating | Operating | Light Focus | | |
|---|---|---|---|---|---|---|---|
| Type | Wavelength | Power | Current | Voltage | Diameter | Dimensions | |
| Number | (nm) | (W) | (ampere (A)) | (volt (V)) | (FWHM) | (Width × Height × Depth) | Weight |
| L11585-02 | 940 | 2000 | 82 | 46 | 1.3 mm × | 165 mm × 160 mm × | 14 kg |
| L11585-04 | | 4000 | 93 | 94 | 0.4 mm | 414 mm | 15 kg |

Specifically, Table 1 represents high-power lasers manufactured by “Coherent Laser.” These lasers have different powers ranging from 4 kW to 10 kW. The beams of these laser are straight lines with dimensions ranging from 6 mm to 36 mm in length and 1 mm to 12 mm in width. Table 2 represents high-power lasers manufactured by Hamamatsu with power being as high as 4 kW and having circular beams with the dimensions described in Table 2. In one or more embodiments, one or any of these lasers may be integrated into the downhole laser tool described below in accordance with one or more embodiments. According to one or more embodiments, the shape of the laser beam may be chosen based on a specific application of the downhole laser tool. For example, the straight line laser beam may be used for cutting a casing. In another example, the circular laser beam may be used for drilling, perforation, heating, or casing cutting.

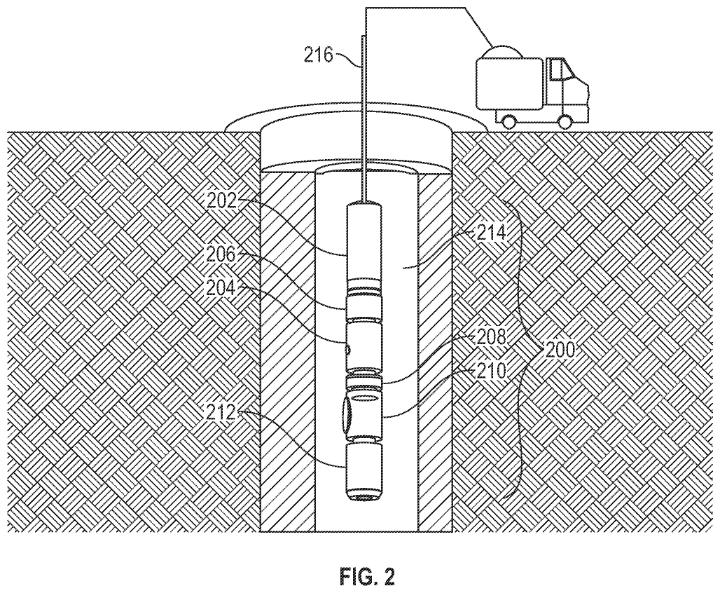

FIG. 2 shows deploying a downhole laser tool (200) in a downhole environment (214) of a well, in accordance with one or more embodiments. The downhole laser tool (200) may be sufficiently compact and light to be lowered in the downhole environment (214) via coiled tubing or any other means, for example by using a moving reel. The coiled tubing may be carried on and dispensed by a supplying vehicle into the downhole environment (214). The supplying vehicle may include an electric power generator to generate enough power for powering the downhole laser tool (200). The supplying vehicle may also provide fluid (gas or liquid) for purging hoses/nozzles of the downhole laser tool, which are described in one or more embodiments further below. The fluid may be provided by using a coiled tubing from an above-surface supply to the downhole laser tool. In one example, the fluid may be nitrogen. A power cable (216) may be connected to the downhole laser tool (200) to provide electric power to the downhole laser tool. The power cable (216) may be cased or shielded for protection of the power cable (216) inside the downhole environment (214). The casing of the power cable (216) may be made of any materials commercially available to protect the power cable (214) from high temperature, high pressure, or fluid/gas/particle invasion to the power cable (214).

The downhole laser tool (200) shown in FIG. 2 includes a laser unit (202). The laser unit (202) includes a laser that may be, for example, a Direct Diode Laser described above with reference to Table 1 or Table 2. The downhole laser tool (200) further includes a first rotational joint (206), a first segment (204), a second rotational joint (208), a second segment (210), and a third segment (212). The first rotational joint (206) is disposed between the laser unit (202) and the first segment (204) and connects the laser unit (202) to the first segment (204). The first rotational joint (206) can rotate the first segment (204) around the longitudinal axial of the first segment (204). The second rotational joint (208) can rotate the second segment (210) around the longitudinal axial of the second segment (210). The laser unit (202), the first rotational joint (206), the first segment (204), the second rotational joint (208), the second segment (210), and the third segment (212) are disposed longitudinally along the well. During operation of the downhole laser tool (200), the laser unit (202), the first rotational joint (206), the first segment (204), the second rotational joint (208), the second segment (210), and the third segment (212) navigate in the downhole environment (214) as one integral tool. The size of the downhole laser tool (200), in accordance with one or more embodiments, may range from 2 inches to 7 inches and more in diameter. The 2 inches in diameter downhole laser tool (200) may be light enough to be portable and handheld by a person.

According to one or more embodiments, the first segment (204) may be a perforation or tunneling segment that can create perforations or holes in a sidewall of the downhole environment (214), by emitting the laser beam of the laser unit (202) on the sidewall of the downhole environment (214). The first rotational joint (206) can control rotation of the first segment (204) to control the radial orientation of the laser beam emitted by the first segment (204) on the sidewall of the downhole environment (214), for example for creating the perforations. The rotation of the first segment (204) may be controlled, for example in 360 degrees. In one or more embodiments, the second segment (210) may be a heating segment that can heat a sidewall of the downhole environment (214). The heating may be applied for, for example, treatment of a casing or stimulation of hydrocarbon flow. The second rotational joint (208) can control rotation of the second segment (210) to control the radial orientation of the laser beam emitted by the second segment (210) on the sidewall of the downhole environment (214), for example for heating the sidewall. The rotation of the second segment (210) may be controlled, for example in 360 degrees. Further, in one or more embodiments, the third segment (212) may be, for example, a drilling segment that can emit the laser beam downward in the downhole environment (214) to drill the well and move the downhole laser tool (200) further in the well.

In one or more embodiments, the rotational joints are a mechanical device that is used to mechanically rotate two joints, and is powered by electric or hydraulic power. The rotational joints may include a shaft, which rotates with the rotating part, seals and a bearing. The rotational joints may be connected to the laser unit, the tunnelling/segment and the heating segment by being bolted to the other segments. Further, each rotational segment rotates independently.

In one or more embodiments, the order of the first segment (204) and the second segment (208) may be switched. In other words, the second segment (208) may be disposed after the laser unit (202) before the first segment (204).

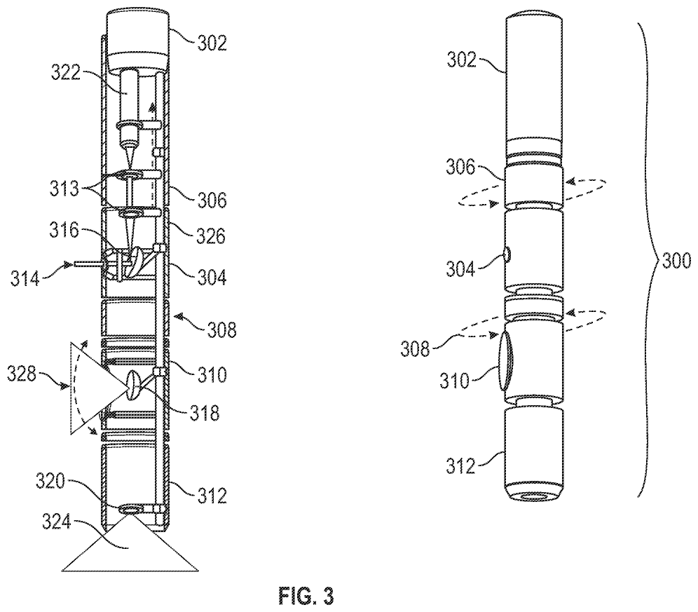

FIG. 3 further describes the components of the downhole laser tool (300), in accordance with one or more embodiments. The laser unit (302) of the downhole laser tool (300) may operate as an in-situ laser tool, inside the downhole environment. The laser unit (302) includes a laser (322). The laser (322) may be, for example, a laser described above with reference to Table 1 or Table 2. The laser (322) generates and releases the laser beam. The laser unit (302) is attached to the first rotational joint (306), which rotates the first segment (304) with respect to the laser unit (302). The first segment (304) includes optics such as lenses of the first segment (313) and a first retractable reflector (316) to guide the laser beam toward a first aperture (314) of the first segment (304). The second segment (310) is connected to the second directional joint (308) that can rotate the second segment (310) with respect to the first segment (304) or the laser unit (302). The second segment (310) also includes optics such as a second retractable reflector (318) to guide the laser beam toward a second aperture (328) of the second segment (310). The third segment (312) is disposed at a longitudinal end of the downhole laser tool (300). The third segment (312) includes optics, such as a lens of the third segment (320) to guide the laser beam toward a third aperture (324) of the third segment (312). The optics of the first segment, second segment, and third segment may be mounted on one or more optical holders. For example, as shown in FIG. 3, the optics of the first segment, second segment, and third segment are mounted on an optical holder (326). The optical holder (326) may be a segment that functions as a case for the optics, and may be a different color so it can be identified in case of repair or maintenance.

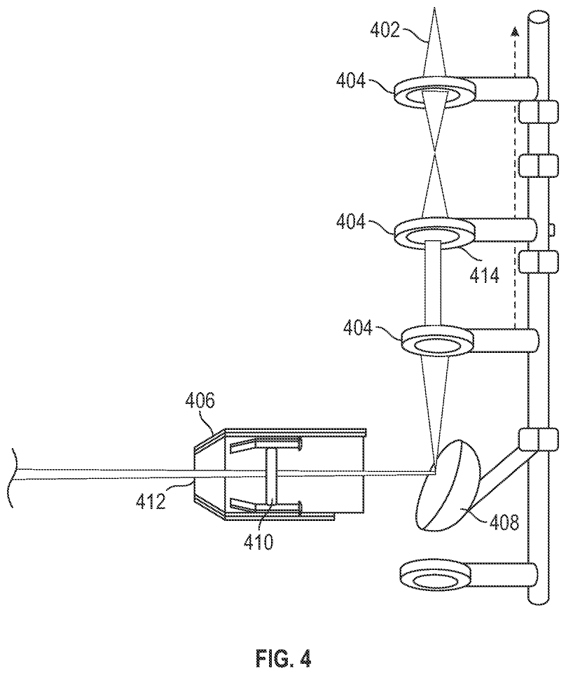

With reference to FIGS. 4-6, examples of the first segment, the second segment, and the third segment are described below, in accordance with one or more embodiments.

FIG. 4 shows an example of the first segment, in accordance with one or more embodiments. As described above, the first segment may be used to create perforations in a sidewall of the downhole environment. In one example, the first segment can cut a casing by using the high-power laser beam. The first segment shown in FIG. 4 includes lenses of the first segment (404), a first retractable reflector (408), and a first aperture (412). The lenses of the first segment (404) and the first retractable reflector (408) can guide the laser beam (402) toward the first aperture (412). The lenses of the first segment (404) includes a collimator lens (414) to collimate the laser beam (402) and guide the laser beam (402) toward the first retractable reflector (408). The orientation or position of the first retractable reflector (408) can be controlled via an actuator. The actuator may be electric or hydraulic and can move the first retractable reflector (408). Upon positioning the first retractable reflector (408) on the path of the laser beam (402), the laser beam (402) can be reflected toward the first aperture (412). On the other hand, upon positioning the first retractable reflector (408) out of the path of the laser beam (402), the laser beam (402) can path through the first segment into the portions of the downhole laser tool that follow after the first segment, such as the second rotational joint, the second segment, or the third segment. The first retractable reflector (408) may be a mirror, a beam splitter, or a prism. In one or more embodiments, the first retractable reflector (408) may shape the laser beam (402) to adjust spatial dimensions of the laser beam (402) at a sidewall of the downhole environment, based on specific application of the laser beam (402). For example, the first retractable reflector (408) may sufficiently narrow the laser beam (402) for concentrating the energy of the laser beam (402) in a small space, for example for creating tunnels or perforations in the sidewall of the downhole environment.

The first aperture (412) includes a first cover lens (410) that covers and protects the first aperture (412) and that passes the laser beam (402) through the first aperture (412) to the downhole environment. The first cover lens (410) blocks debris, that may be back scattered, from entering the first segment. In one or more embodiments, the first cover lens (410) may be just a transparent cover that does not alter the shape of the laser beam (402). Alternatively, the first cover lens (410) may be a magnifying/demagnifying lens that can alter the shape of the laser beam (402).

The first aperture (412) further includes a first purging hose (406) that ejects a fluid to an outer side of the first aperture (412), to sweep debris away from the first aperture (412). The fluid may also cool components of the first segment, such as the first cover lens (410) and the first aperture (412). The fluid may also run around the laser unit described above, to cool the laser. The fluid may be gas or liquid that may be supplied by, for example, the supplying vehicle. In one or more embodiments, the first purging hose (406) is disposed around the first cover lens (410), to sweep the debris away from the outer surface of the first cover lens (410). In one or more embodiments, the first purging hose (406) includes a plurality of nozzles. The plurality of nozzles may be disposed around the cover lens (410). For example, in FIG. 4, the first purging hose (406) includes two nozzles around the first cover lens (410).

In one or more embodiments, the optical lenses and reflectors are used to direct the laser beam either vertically from the drilling segment, or horizontally from either the perforation/tunnelling segment or the heating segment. In addition, in one or more embodiments, the laser beam may also be tilted to create an inclined wellbore deviating from a vertical wellbore by tilting the tool or the rotational segment.

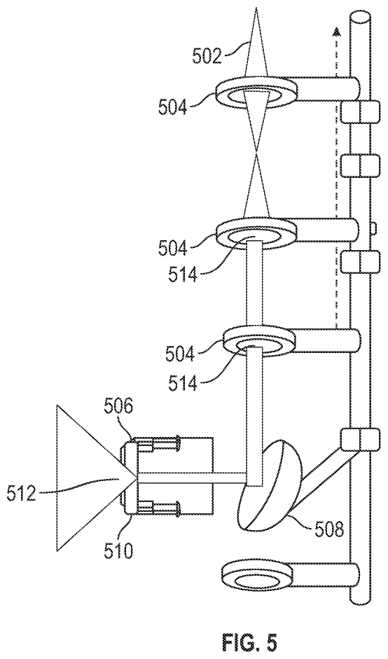

FIG. 5 shows an example of the second segment, in accordance with one or more embodiments. As described above, the second segment may be used to heat a sidewall of the downhole environment, for example for treatment of a casing. The second segment shown in FIG. 5 includes lenses of the second segment (504), a second retractable reflector (508), and a second aperture (512). The lenses of the second segment (504) and the second retractable reflector (508) can guide the laser beam (502) toward the second aperture (512). The lenses of the second segment (504) include collimator lenses (514) to collimate the laser beam (502) and guide the laser beam (502) toward the second retractable reflector (508). The orientation or position of the second retractable reflector (508) can be controlled via an actuator. The actuator may be electric or hydraulic. Upon positioning the second retractable reflector (508) on the path of the laser beam (502), the laser beam (502) can be reflected toward the second aperture (512). On the other hand, upon positioning the second retractable reflector (508) out of the path of the laser beam (502), the laser beam (502) can pass through the second segment into the portions of the downhole laser tool that follow after the second segment, such as the third segment. The second retractable reflector (508) may be a mirror, a beam splitter, or a prism. In one or more embodiments, the second retractable reflector may shape the laser beam (502) to adjust spatial dimensions of the laser beam (502) at a sidewall of the downhole environment, based on specific application of the laser beam (502). For example, the second retractable reflector may make the laser beam (502) sufficiently spatially wide, for example for heating and treatment of a casing. Alternatively, the second retractable reflector (508) may not shape the laser beam (502), as shown in FIG. 5.

The second aperture (512) includes a second cover lens (510) that covers and protects the second aperture (512) and that passes the laser beam (502) through the second aperture (512) to the downhole environment. The second cover lens (510) blocks debris, that may be back scattered, from entering the second segment. In one or more embodiments, the second cover lens may be just a transparent cover that does not alter the shape of the laser beam (502). Alternatively, the second cover lens (510) may be a magnifying/demagnifying lens that can alter the shape of the laser beam (502), for example spatially widen the laser beam (502) as shown in FIG. 5. In one example, the laser beam at the target area can be widened to a diameter from 2 inches to 20 inches, for example for heating. The spatial size of the laser beam at the target area can be controlled by the sizes and relative distances between the optics in any of the portions of the downhole laser tool.

The second aperture (512) further includes a second purging hose (506) that ejects a fluid to an outer side of the second aperture (512), to sweep debris away from the second aperture (512). The fluid may also cool components of the second segment, such as the second cover lens (510) and the second aperture (512). The fluid may be the same as the fluid that is ejected by the first purging hose (406) described above with reference to FIG. 4. In one or more embodiments, the second purging hose (506) is disposed around the second cover lens (510), to sweep the debris away from the outer surface of the second cover lens (510). In one or more embodiments, the second purging hose (506) includes a plurality of nozzles. The plurality of nozzles of the second purging hose may be disposed around the cover lens (510). For example, in FIG. 5, the second purging hose (506) includes two nozzles around the second cover lens (510).

The second segment shown in FIG. 5 spatially widens the laser beam (502), to heat a larger area at a target zone. The heating has different application such as fracturing, casing treatment, and clay treatment. The size of the area that may be heated by the heating segment depends on the lens size, which is adjustable and may range from 2″ to more than 20″. Further, in one or more embodiments, a user may control how large of an output beam is produced in the heating segment by controlling the lens size and adjust the lens location back and forth.

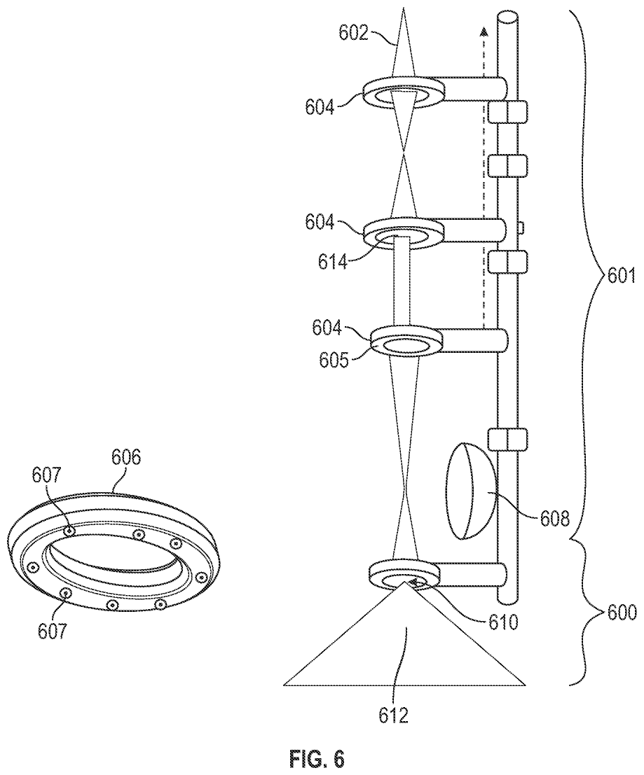

FIG. 6 shows an example of the third segment (600) that is coupled to the second segment (601), in accordance with one or more embodiments. As described above, the third segment (600) may be used for drilling the well. As described above with reference to FIG. 5, the second segment (601) includes lenses of the second segment (604) and a second retractable reflector (608). The lenses of the second segment (604) include a collimator lens (614) to collimate the laser beam (602) and a focus lens (605) to focus the laser beam (602). The third segment (600) shown in FIG. 6 spatially adjusts the dimensions of the laser beam (602) at the target location at the third aperture (612) of the third segment (600). When the first retractable reflector (for example (408) in FIG. 4) and the second retractable reflector (608) retract, the lenses of the second segment (604) guide the laser beam (602) toward the lens of the third segment (610) and the third aperture (612). In one or more embodiments, the third segment may include more optics, for example, more lenses or mirrors, to guide and shape the laser beam (602) based on a specific function or application of the third segment (600).

In one or more embodiments, the lens of the third segment (610) may be a cover lens that covers and protects the third aperture (612) and that passes the laser beam (602) through the third aperture (612) to the downhole environment. The cover lens of the third segment blocks debris, that may be back scattered, from entering the third segment (600). In one or more embodiments, the cover lens of the third segment may be just a transparent cover that does not alter the shape of the laser beam (602). In this case, there may be another lens in the third segment, before the cover lens, that shapes the laser beam (602). Alternatively, the cover lens may be a magnifying/demagnifying lens that can alter the shape of the laser beam (602), for example spatially widen the laser beam (602) as shown by the lens of the third segment (610) in FIG. 6.

The third segment (600) further includes a third purging hose (606) that ejects a fluid to an outer side of the third aperture (612), to sweep debris away from the third aperture (612). The fluid may also cool components of the third segment, such as the cover lens of the third segment and the third aperture (612). The fluid may be the same as the fluid that is ejected by the first purging hose (406) described above with reference to FIG. 4. In one or more embodiments, the third purging hose (606) is disposed around the cover lens of the third segment, to sweep the debris away from the outer surface of the cover lens of the third segment. In one or more embodiments, the third purging hose (606) is coaxial with the lens of the third segment and ejects the fluid coaxially with the cover lens of the third segment. In one or more embodiments, the third purging hose (606) includes a plurality of nozzles (607) that are disposed, on the third purging hose (606), coaxially with the cover lens of the third segment. The coaxial purge may generate high-pressure flow of fluid in the same direction as the laser beam emission at the third aperture (612). The coaxial purge is a gas/fluid pipe that is connected from the surface, the gas and fluid passes through the pipe to the target clearing the beam path and removing the debris.

In one or more embodiments, the movable components of the downhole laser tool such as the first and second rotational joints, the actuators that control positions of the first and second retractable reflectors, and the optical holder, can be controlled and moved by electric or hydraulic systems.

In view of the above, the downhole laser tool described in accordance with one or more embodiments herein is a versatile tool that may: improve stimulated reservoir volume; improve perforations; drill in any direction and any formation; substitute heat for water for fracturing; create controlled clean holes; treat casing or clay; or apply heating treatment to improve flow and production. In one example, the heating treatment may be used to reduce viscosity of oil for better flow and easier extraction from reservoir. In addition, the downhole laser tool described in accordance with one or more embodiments herein may be cost effective, have small carbon footprint, and have low emission. Further, the downhole laser tool may operate at any depth, and power loss may not be an issue.

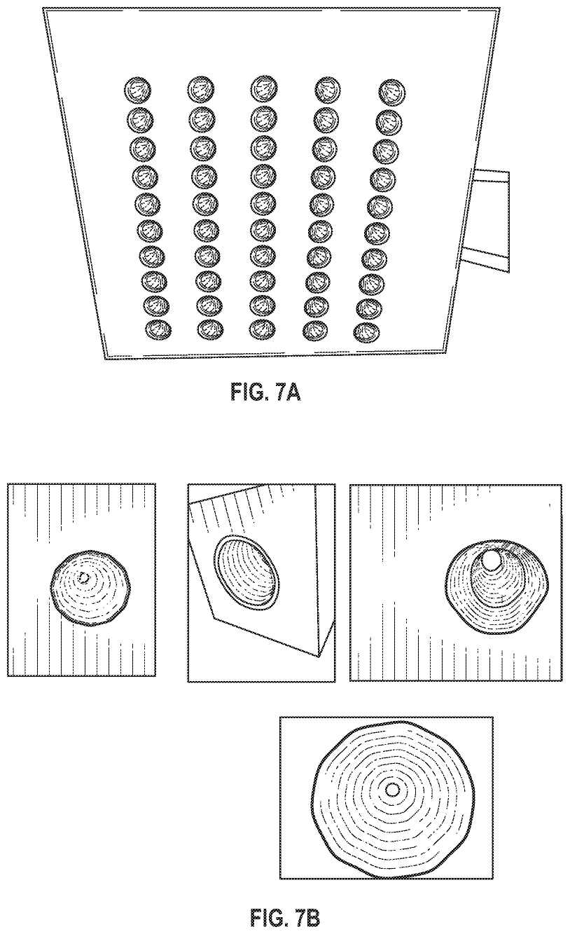

FIGS. 7A and 7B show some examples of applications of the downhole laser tool in accordance with one or more embodiments disclosed herein. Specifically, FIG. 7A shows perforations created by the first segment of the downhole laser tool in a concrete block. FIG. 7B shows larger holes that are drilled via the third segment of the downhole laser tool in concrete blocks.

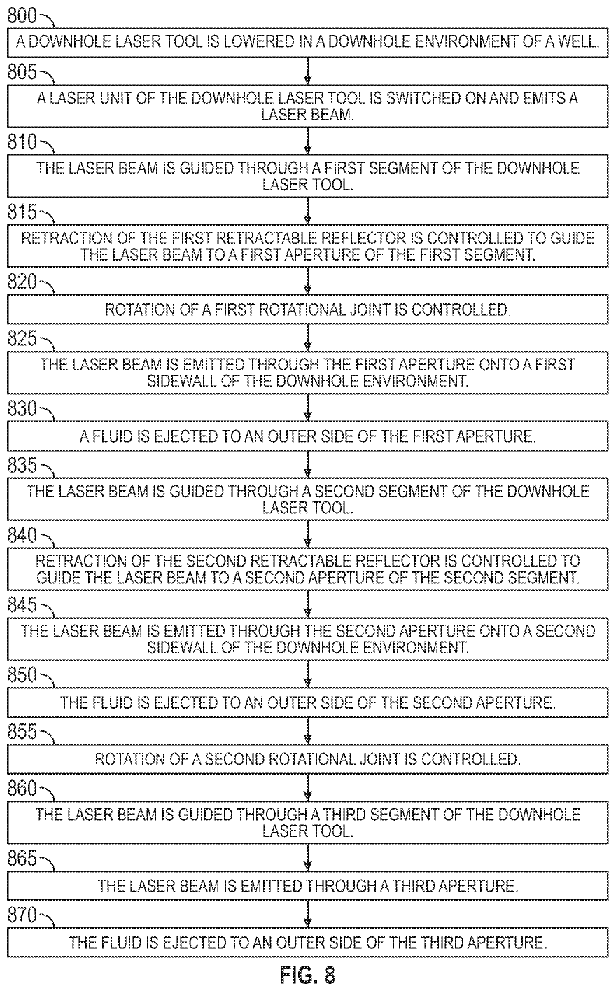

FIG. 8 shows a flowchart for operating a downhole laser tool, in accordance with one or more embodiments. In one or more embodiments, one or more of the steps shown in FIG. 8 may be omitted, repeated, and/or performed in a different order than the order shown in FIG. 8. Accordingly, the scope of the invention should not be considered limited to the specific arrangement of the steps shown in FIG. 8. The steps shown in FIG. 8 are explained below.

In Step 800, a downhole laser tool is lowered in a downhole environment of a well. Examples of this step are described above with reference to FIGS. 1 and 2. In Step 805, a laser unit of the downhole laser tool is switched ON. The laser unit comprises a laser that emits a laser beam. Examples of the laser unit are described above with reference to FIG. 3 and Tables 1 and 2.

In Step 810, the laser beam is guided, through a first segment of the downhole laser tool, using one or more lenses of the first segment and a first retractable reflector of the first segment. Some examples of this step are described above with reference to FIG. 4. In Step 815, retraction of the first retractable reflector is controlled to guide the laser beam to a first aperture of the first segment that passes the laser beam to the downhole environment. Some examples of this step are described above with reference to the first retractable reflector (408) shown in FIG. 4. In Step 820, rotation of a first rotational joint, disposed between the laser unit and the first segment, that connects the laser unit to the first segment and rotates the first aperture, is controlled. Some examples of this step are described above with reference to the first rotational joint (206, 306) shown in FIGS. 2 and 3. In Step 825, the laser beam is emitted through the first aperture onto a first sidewall of the downhole environment. Some examples of this step are described above with reference to emission of the laser beam (402) through the first aperture (412) as shown in FIG. 4. In Step 830, a fluid is ejected to an outer side of the first aperture, to sweep debris away from the first aperture. Some examples of this step are described above with reference to the first purging hose (406) shown in FIG. 4.

In Step 835, the laser beam is guided through a second segment of the downhole laser tool, using one or more lenses of the second segment and a second retractable reflector of the second segment. Some examples of this step are described above with reference to the second segment shown in FIGS. 3 and 5. In Step 840, retraction of the second retractable reflector is controlled to guide the laser beam to a second aperture of the second segment that passes the laser beam to the downhole environment. Some examples of this step are described above with reference to the second retractable reflector (508) shown in FIG. 5. In Step 845, the laser beam is emitted through the second aperture onto a second sidewall of the downhole environment. Some examples of this step are described above with reference to emission of the laser beam (502) through the second aperture (512) as shown in FIG. 5. In Step 850, The fluid is ejected to an outer side of the second aperture, to sweep debris away from the second aperture. Some examples of this step are described above, with reference to the second purging hose (506) shown in FIG. 5. In Step 855, rotation of a second rotational joint, disposed between the first segment and the second segment, that connects the first segment to the second segment and rotates the second aperture, is controlled. Some examples of this step are described above with reference to the second rotational joint (208, 308) shown in FIGS. 2 and 3.

In Step 860, the laser beam is guided through a third segment of the downhole laser tool, using a lens of the third segment. The lens of the third segment guides the laser beam to a third aperture of the third segment disposed at a longitudinal end of the downhole laser tool. Some examples of this step are described above with reference to the third segment (600) shown in FIG. 6. In Step 865, the laser beam is emitted through the third aperture to drill the downhole environment. Some examples of this step are described above with reference to FIG. 6. In Step 870, the fluid is ejected to an outer side of the third aperture, to sweep debris away from the third aperture. Some examples of this step are described above with reference to the third purging hose (606) shown in FIG. 6.

In one or more embodiments, based on the above Steps, the downhole laser tool can be operated to emit the laser beam though any of the first aperture, second aperture, or third aperture for specific applications. For example, with reference to Step 825, the downhole laser tool can be operated to emit the laser beam through the first aperture onto the first sidewall of the downhole environment to make perforations in the first sidewall. In another example, with reference to Step 845, the downhole laser tool can be operated to emit the laser beam through the second aperture onto the second sidewall of the downhole environment to heat up the second sidewall for treatment or stimulation. In another example, with reference to Step 865, the downhole laser tool can be operated to emit the laser beam through the third aperture to drill the downhole environment and move the downhole laser tool further in the well.

In one or more embodiments, in the step for lowering of the downhole laser tool in the downhole environment, the laser unit, the first rotational joint, the first segment, the second rotational joint, the second segment, and the third segment are disposed longitudinally along the well. Further, in one or more embodiments, during operation of the downhole laser tool, the laser unit, the first rotational joint, the first segment, the second rotational joint, the second segment, and the third segment navigate in the downhole environment as one integral tool.

One or more embodiments disclosed herein for operating the downhole laser tool, for example with reference to FIG. 8, may be implemented on virtually any type of computer system, regardless of the platform being used. The computer system may have programs or algorithms to control the functions/operations of the downhole laser tool described in the above embodiments. For example, the computer system may be one or more mobile devices (e.g., laptop computer, smart phone, personal digital assistant, tablet computer, or other mobile device), desktop computers, servers, blades in a server chassis, or any other type of computer system that includes at least the minimum processing power, memory, and input and output device(s) to perform one or more embodiments of the invention.

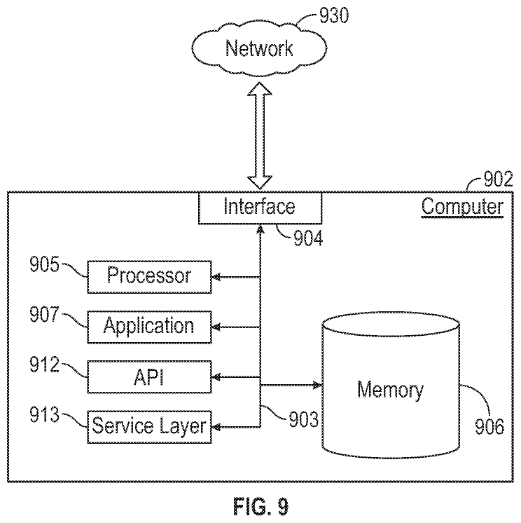

An example of the computer system is described with reference to FIG. 9, in accordance with one or more embodiments. FIG. 9 is a block diagram of a computer system used to provide computational functionalities associated with described algorithms, methods, functions, processes, flows, and procedures as described in the instant disclosure, according to an implementation. The illustrated computer (902) in the computer system is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. The illustrated computer (902) is communicably coupled with a network (930). In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902)) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913)). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer (913). Software services, such as those provided by the service layer (913), provide reusable, defined business functionalities through a defined interface. For example, the interface may be software written in JAVA, C++, Python, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). For example, memory (906) can be a database storing data consistent with this disclosure. In one example, memory (906) may store programs or algorithms for controlling operation of the components of the downhole laser tool such as the laser unit, the first segment, the first rotational joint, the second segment, the second rotational joint, and the third segment described above in accordance with one or more embodiments. For example, the programs or algorithms may control operation of the laser, the optical holder, the actuators, the retractable reflectors, and the purging hoses described above in accordance with one or more embodiments. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, the application (907) can serve as one or more components, modules, applications, etc. In one example, the application (907) may include programs or algorithms for controlling operation of the components of the downhole laser tool such as the laser unit, the first segment, the first rotational joint, the second segment, the second rotational joint, and the third segment described above in accordance with one or more embodiments. For example, the programs or algorithms may control operation of the laser, the optical holder, the actuators, the retractable reflectors, and the purging hoses described above in accordance with one or more embodiments. Further, although illustrated as a single application (907), the application (907) may be implemented as multiple applications (907) on the computer (902). In addition, although illustrated as integral to the computer (902), in alternative implementations, the application (907) can be external to the computer (902). In one example, the method described with reference to FIG. 8 may be implemented by the application (907).

There may be any number of computers (902) associated with, or external to, a computer system containing computer (902), each computer (902) communicating over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902). Furthermore, in one or more embodiments, the computer (902) is a non-transitory computer readable medium (CRM).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A downhole laser tool comprising:
a laser unit comprising a laser that generates a laser beam in a downhole environment of a well;
a first segment comprising:
one or more lenses of the first segment;
a first retractable reflector; and
a first aperture,
wherein the one or more lenses of the first segment and the first retractable reflector guide the laser beam to the first aperture that passes the laser beam to the downhole environment; and
a first rotational joint, disposed between the laser unit and the first segment, that connects the laser unit to the first segment and rotates the first segment,
wherein the laser unit, the first rotational joint, and the first segment are disposed longitudinally along the well, and
wherein, during operation of the downhole laser tool, the laser unit, the first rotational joint, and the first segment navigate in the downhole environment as one integral tool.

2. The downhole laser tool of claim 1, further comprising:
a second segment comprising:
one or more lenses of the second segment;
a second retractable reflector; and
a second aperture,
wherein the one or more lenses of the second segment and the second retractable reflector guide the laser beam to the second aperture that passes the laser beam to the downhole environment.

3. The downhole laser tool of claim 2, further comprising:
a second rotational joint, disposed between the first segment and the second segment, that connects the first segment to the second segment and rotates the second segment,
wherein the laser unit, the first rotational joint, the first segment, the second rotational joint, and the second segment are disposed longitudinally along the well, and
wherein, during operation of the downhole laser tool, the laser unit, the first rotational joint, the first segment, the second rotational joint, and the second segment navigate in the downhole environment as one integral tool.

4. The downhole laser tool of claim 2, further comprising:
a third segment comprising:
a lens of the third segment; and
a third aperture disposed at a longitudinal end of the downhole laser tool,
wherein the lens of the third segment guides the laser beam to the third aperture, and
wherein the laser beam is emitted through the third aperture to drill the downhole environment.

5. The downhole laser tool of claim 1, where the first segment further comprises:
a first-segment cover lens that protects the first aperture and that passes the laser beam through the first aperture to the downhole environment,
wherein the first-segment cover lens blocks debris from entering the first segment; and
a first-segment purging hose that ejects a fluid to an outer side of the first aperture, to sweep debris away from the first aperture.

6. The downhole laser tool of claim 2, where the second segment further comprises:
a second-segment cover lens that protects the second aperture and that passes the laser beam through the second aperture to the downhole environment,
wherein the second-segment cover lens blocks debris from entering the second segment; and
a second-segment purging hose that ejects a fluid to an outer side of the second aperture, to sweep debris away from the second aperture.

7. The downhole laser tool of claim 6, wherein the second-segment cover lens diverges the laser beam.

8. The downhole laser tool of claim 4, wherein the third segment further comprises:
a third-segment purging hose that ejects a fluid to an outer side of the third aperture, to sweep debris away from the third aperture.

9. The downhole laser tool of claim 8, wherein the third-segment purging hose is coaxial with the lens of the third segment and ejects the fluid coaxially with the lens of the third segment.

10. The downhole laser tool of claim 9, wherein the third-segment purging hose comprises a plurality of nozzles that are disposed, on the third-segment purging hose, coaxially with the lens of the third segment.

11. The downhole laser tool of claim 1, wherein the laser beam emitted from the first aperture to the downhole environment perforates a sidewall of the downhole environment.

12. The downhole laser tool of claim 1, wherein at least one of the one or more lenses of the first segment is a collimator lens that collimates the laser beam.

13. The downhole laser tool of claim 2, wherein at least one of the one or more lenses of the second segment is a collimator lens that collimates the laser beam.

14. The downhole laser tool of claim 2, wherein upon retraction of the first retractable reflector, the laser beam passes through the first segment into the second segment.

15. The downhole laser tool of claim 4, wherein upon retraction of the first retractable reflector and retraction of the second retractable reflector, the laser beam passes through the first segment and the second segment into the third segment.

16. The downhole laser tool of claim 4,
wherein the laser unit, the first rotational joint, the first segment, the second rotational joint, the second segment, and the third segment are disposed longitudinally along the well, and
wherein, during operation of the downhole laser tool, the first rotational joint, the first segment, the second rotational joint, the second segment, and the third segment navigate in the downhole environment as one integral tool.

17. A method for operating a downhole laser tool, the method comprising:
lowering the downhole laser tool in a downhole environment of a well;
turning ON a laser unit of the downhole laser tool, the laser unit comprising a laser emitting a laser beam;
guiding the laser beam, through a first segment of the downhole laser tool, using one or more lenses of the first segment and a first retractable reflector of the first segment;
controlling retraction of the first retractable reflector to guide the laser beam to a first aperture of the first segment that passes the laser beam to the downhole environment;
controlling rotation of a first rotational joint, disposed between the laser unit and the first segment, that connects the laser unit to the first segment and rotates the first aperture;
emitting the laser beam through the first aperture onto a first sidewall of the downhole environment; and
ejecting a fluid to an outer side of the first aperture, to sweep debris away from the first aperture,
wherein in the lowering of the downhole laser tool in the downhole environment, the laser unit, the first rotational joint, and the first segment are disposed longitudinally along the well, and
wherein, during operation of the downhole laser tool, the laser unit, the first rotational joint, and the first segment navigate in the downhole environment as one integral tool.

18. The method of claim 17, further comprising:
guiding the laser beam through a second segment of the downhole laser tool, using one or more lenses of the second segment and a second retractable reflector of the second segment;
controlling retraction of the second retractable reflector to guide the laser beam to a second aperture of the second segment that passes the laser beam to the downhole environment;
emitting the laser beam through the second aperture onto a second sidewall of the downhole environment; and
ejecting the fluid to an outer side of the second aperture, to sweep debris away from the second aperture.

19. The method of claim 18, further comprising:
controlling rotation of a second rotational joint, disposed between the first segment and the second segment, that connects the first segment to the second segment and rotates the second aperture,
wherein in the lowering of the downhole laser tool in the downhole environment, the laser unit, the first rotational joint, the first segment, the second rotational joint, and the second segment are disposed longitudinally along the well, and
wherein, during operation of the downhole laser tool, the laser unit, the first rotational joint, the first segment, the second rotational joint, and the second segment navigate in the downhole environment as one integral tool.

20. The method of claim 19, further comprising:
guiding the laser beam through a third segment of the downhole laser tool, using a lens of the third segment,
wherein the lens of the third segment guides the laser beam to a third aperture of the third segment disposed at a longitudinal end of the downhole laser tool;
ejecting the fluid to an outer side of the third aperture, to sweep debris away from the third aperture; and
emitting the laser through the third aperture to drill the downhole environment.
